(19) United States
(12) Patent Application Publication
(10) Pub. No.: US 2026/0169541 A1
(43) Pub. Date: Jun. 18, 2026

(54) POWER MANAGEMENT FOR A DEVICE BASED ON A PEAK POWER CONSUMPTION LEVEL

(71) Applicant: QUALCOMM Incorporated, San Diego, CA (US)

(72) Inventors: Louis Louie, San Diego, CA (US); Ronald Alton, Oceanside, CA (US); Melanie Dolores Oclima, San Diego, CA (US); Todd Robert Sutton, Del Mar, CA (US); Eric Mikuteit, San Diego, CA (US); Xu Chi, San Diego, CA (US); Gordon Lee, Gilbert, AZ (US)

(21) Appl. No.: 18/984,129

(22) Filed: Dec. 17, 2024

(51) Int. Cl. G06F 1/3212; G06F 1/3234

(52) U.S. Cl. CPC G06F 1/3212; G06F 1/3234

(57) ABSTRACT

An apparatus for power management of a device includes a processing system including one or more processors and one or more memories coupled to the one or more processors. The processing system is configured to receive power usage information associated with the device and to receive a battery power availability (BPA) indication associated with a battery of the device. The processing system is further configured to adjust, based on the power usage information and the BPA indication, a power allocation associated with the device to enable operation of the device based on a peak power consumption level. The peak power consumption level is less than a threshold power consumption level that is associated with power consumption throttling of one or more components of the device.

### TECHNICAL FIELD

Aspects of the present disclosure relate generally to electronic devices, and more particularly, to power management for electronic devices that use batteries, such as silicon anode batteries and other types of batteries.

### INTRODUCTION

Electronic devices increasingly perform a variety of functions for users. For example, in addition to supporting voice calls, a mobile device (such as a smart phone) may support a variety of other operations and may include a variety of electronic components to support these operations. As another example, a vehicle may support wireless communications, navigation, and other driver assistance features such as adaptive cruise control, lane change assistance, collision avoidance, night vision, parking assistance, blind spot detection, lane keeping assistance, automated braking, partially autonomous driving, and fully autonomous driving.

To enable these and other features, devices may include one or more integrated circuits. One example of an integrated circuit is a system-on-chip (SoC). SoCs and other integrated circuits may use power management techniques to improve performance. As new technologies and devices emerge, some power management techniques may be insufficient to provide quality user experience or device performance. For example, as electronic devices increasingly perform a wide variety of operations, some power management techniques may subject a battery of a device to a large amount of loading. As a result, a battery may be rapidly discharged, requiring recharging.

### BRIEF SUMMARY OF SOME EXAMPLES

The systems, methods and devices of this disclosure each have several innovative aspects, no single one of which is solely responsible for the desirable attributes disclosed herein.

In some aspects, an apparatus for power management of a device includes a processing system including one or more processors and one or more memories coupled to the one or more processors. The processing system is configured to receive power usage information associated with the device and to receive a battery power availability (BPA) indication associated with a battery of the device. The processing system is further configured to adjust, based on the power usage information and the BPA indication, a power allocation associated with the device to enable operation of the device based on a peak power consumption level. The peak power consumption level is less than a threshold power consumption level that is associated with power consumption throttling of one or more components of the device.

In some other aspects, a method of power management for a device includes receiving power usage information associated with the device and receiving a battery power availability (BPA) indication associated with a battery of the device. The method further includes, based on the power usage information and the BPA indication, adjusting a power allocation associated with the device to enable operation of the device based on a peak power consumption level. The peak power consumption level is less than a threshold power consumption level that is associated with power consumption throttling of one or more components of the device.

In some additional aspects, a non-transitory computer-readable medium stores instructions executable by one or more processors to initiate, perform, or control operations for power management of a device. The operations include receiving power usage information associated with the device and receiving a battery power availability (BPA) indication associated with a battery of the device. The operations further include, based on the power usage information and the BPA indication, adjusting a power allocation associated with the device to enable operation of the device based on a peak power consumption level. The peak power consumption level is less than a threshold power consumption level that is associated with power consumption throttling of one or more components of the device.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating an example of a device that supports silicon anode battery based power management.

FIG. 2 depicts some examples that may be associated with a silicon anode battery and that support silicon anode battery based power management.

FIG. 3 depicts a graph illustrating some examples that support silicon anode battery based power management.

FIG. 4 depicts an example of a device that supports silicon anode battery based power management.

FIG. 5 depicts another example of a device that supports silicon anode battery based power management.

FIG. 6 is a flow chart illustrating an example of a method of operation of a device that supports silicon anode battery based power management.

Like reference numbers and designations in the various drawings indicate like elements.

### DETAILED DESCRIPTION

In some aspects of the disclosure, a device may use a proactive power limits scheme to manage discharge and power balancing associated with a battery, such as a silicon anode battery. The proactive power limits scheme may enable sustained system operation at low battery levels, which may reduce or avoid instances of system shutdown as a result of a low battery level. In some examples, the proactive power limits scheme may involve limiting power consumption (and thus limiting current drawn from the silicon anode battery) while the silicon anode battery has a low voltage level, which may reduce or avoid instances of battery brownout.

One or more features described herein may improve operation of a device that uses battery power. To illustrate, some technologies may avoid use of silicon anode batteries due to the relatively high resistances of silicon anode batteries at low charge levels, which may reduce ability of the devices to draw current. As a result, such devices may use some other types of batteries (such as graphite-based batteries) in order to avoid the higher resistances associated with silicon anode batteries. In some aspects, a proactive power limits scheme described herein may selectively reduce current drawn from a silicon anode battery when the silicon anode battery is associated with a low charge level. As a result, the proactive power limits scheme may enable use of silicon anode batteries in a variety of devices, which may enable benefits including, for example, faster charging and discharging, higher energy density, reduced equivalent series resistance (ESR), and “untapped” extra battery capacity at low charge levels as compared to other types of batteries, such as some graphite-based batteries.

In addition, although certain examples may be described with reference to a silicon anode battery for illustration, other examples are also within the scope of the disclosure. To illustrate, one or more features described herein (such as the proactive power limits scheme) may be used in connection with other types of battery technologies, such as other types of rechargeable batteries (e.g., other types of rechargeable lithium ion batteries). In some examples, one or more features described herein (such as the proactive power limits scheme) may be used in connection with one or more of a graphite anode battery, a lithium anode battery, a lithium-sulfur anode battery, a silicon-graphene composite anode battery, or another type of battery, as illustrative examples.

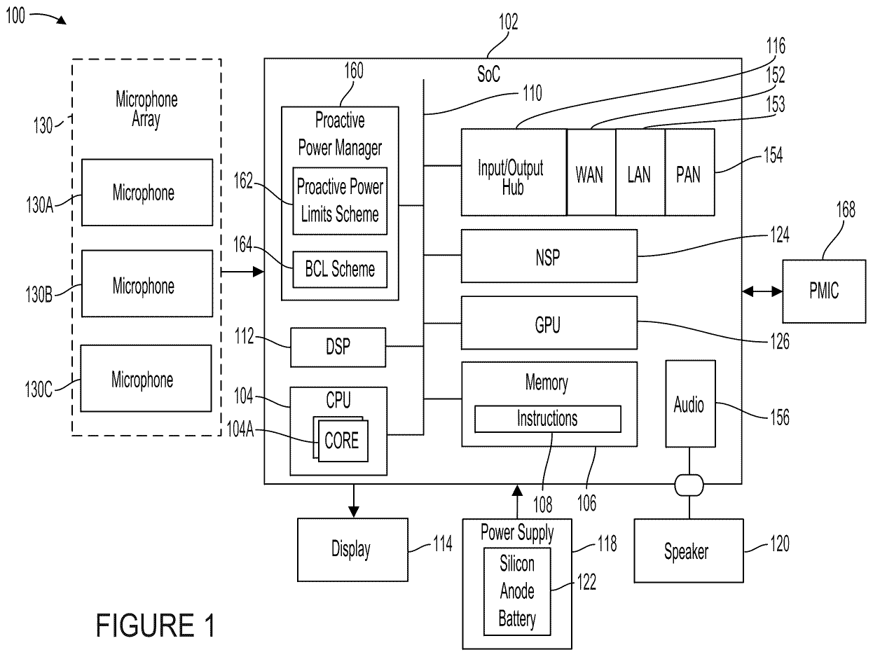

FIG. 1 is a block diagram illustrating an example of a device 100 that supports silicon anode battery based power management. The device 100 may include a system-on-chip (SoC) 102 including several components coupled together through a bus 110, which may be a network-on-a-chip (NoC) or a plurality of NoCs interconnecting various components. For example, although FIG. 1 illustrates several components coupled to the bus 110, the several components may be coupled to different busses with additional busses connecting the different busses to provide a path for communication between the components.

One example component in the SoC 102 is a digital signal processor (DSP) 112 for signal processing. The DSP 112 may process audio signals received from microphones 130A, 130B, and 130C of microphone array 130. The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The SoC 102 also includes a central processing unit (CPU) 104 and a memory 106 storing instructions 108 (e.g., a memory storing processor-readable code or a non-transitory computer-readable medium storing instructions) that may be executed by a processor of the SoC 102. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions 108 retrieved from the memory 106. In some embodiments, the CPU 104 executing an operating system may coordinate execution of instructions by various components within the SoC 102. For example, the CPU 104 may retrieve instructions 108 from memory 106 and execute the instructions on the DSP 112.

The SoC 102 may further include a neural signal processor (NSP) 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data.

The SoC 102 may be coupled to a display 114 for interacting with a user. The SoC 102 may also include a graphics processing unit (GPU) 126 for rendering images on the display 114. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel.

Input/output components may be coupled to the SoC 102 through an input/output (I/O) hub 116. An example of a I/O hub 116 is an interconnect to a peripheral component interconnect express (PCIe) bus. Example components coupled to the I/O hub 116 may be components used for interacting with a user, such as a touch screen interface and/or physical buttons. Some components coupled to the I/O hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the adaptors 152, 153, and 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE).

Audio circuitry 156 may be integrated in SoC 102 as dedicated circuitry for coupling the SoC 102 to a speaker 120 external to the SoC 102, which may be a transducer such as a speaker (either internal to or external to a device incorporating the SoC 102) or headphones. The audio circuitry 156 may include coder/decoder (CODEC) functionality for processing digital audio signals. The audio circuitry 156 may further include one or more amplifiers (e.g., a class-D amplifier) for driving a transducer coupled to the SoC 102 for outputting sounds generated during execution of applications by the SoC 102. Functionality related to audio signals described herein may be performed by a combination of the audio circuitry 156 and/or other processors of the SoC (e.g., CPU 104, DSP 112, GPU 126, NSP 124).

The SoC 102 may couple to external devices outside the package of the SoC 102. For example, the SoC 102 may be coupled to a power supply 118, such as a battery or an adaptor to couple the SoC 102 to an energy source. The signal processing described herein may be adapted to and achieve power efficiency to support operation of the SoC 102 from a limited-capacity power supply 118 such as a battery. For example, operations may be performed on a portion of the SoC 102 configured for performing the operation at a lowest power consumption. As another example, operations themselves are performed in a manner that reduces an amount of computations to perform the operation, such that the algorithm is optimized for extending the operational time of a device while powered by a limited-capacity power supply 118. In some embodiments, the operations described herein may be configured based on a type of power supply 118 providing energy to the SoC 102. For example, a first set of operations may be executed to perform a function when the power supply 118 is a wall adaptor. As another example, a second set of operations may be executed to perform a function when the power supply 118 is a battery.

The SoC 102 may also include or be coupled to additional features or components that are not shown in FIG. 1. Although components are shown integrated as a single SoC 102, which may include all components built on a single semiconductor die with a common semiconductor substrate, other arrangements of the illustrated blocks different number of dies, substrates, and/or packages may be arranged to accomplish the same functionality described in this disclosure. Further, although some examples herein are described with reference to the SoC 102, it should be appreciated that the features described herein are also applicable to other types of integrated circuits.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the SoC 102 that records, processes, or outputs audio signals. The instructions 108 may also include other applications or programs executed by the SoC 102, such as an operating system and applications other than for multimedia processing.

In addition to instructions 108, the memory 106 may also store audio data. The SoC 102 may be coupled to an external memory and configured to access the memory for writing output audio files for later playback or long-term storage. For example, the SoC 102 may be coupled to a flash storage device comprising NAND memory for storing video files (e.g., MP4-container formatted files) including audio tracks and/or storing audio recordings (e.g., MPEG-1 Layer 3 files, also referred to as MP3 files). Portions of the video or audio files may be transferred to memory 106 for processing by the SoC 102, with the resulting signals after processing encoded as video or audio files in the memory 106 for transfer to the long-term storage.

In some aspects, one or more features describe herein may be used in connection with a battery, such as a silicon anode battery 122. The silicon anode battery 122 may be included in the power supply 118. Further, in some aspects, the SoC 102 may be coupled to a power management integrated circuit (PMIC) 168. The PMIC 168 may perform power management operations associated with the SoC 102 and the silicon anode battery 122.

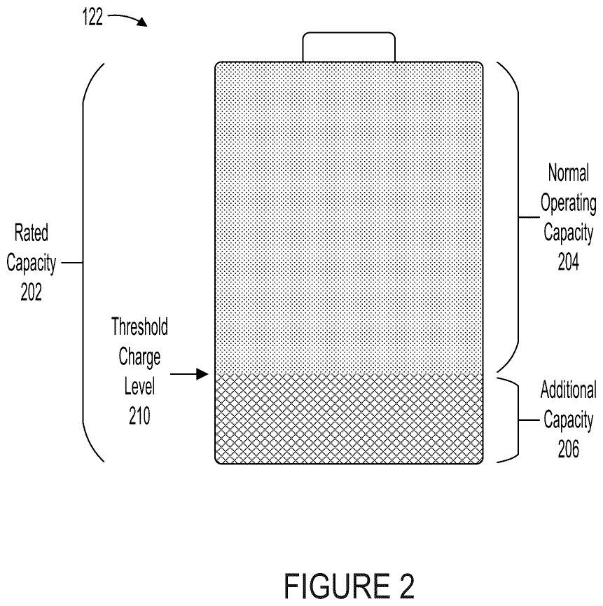

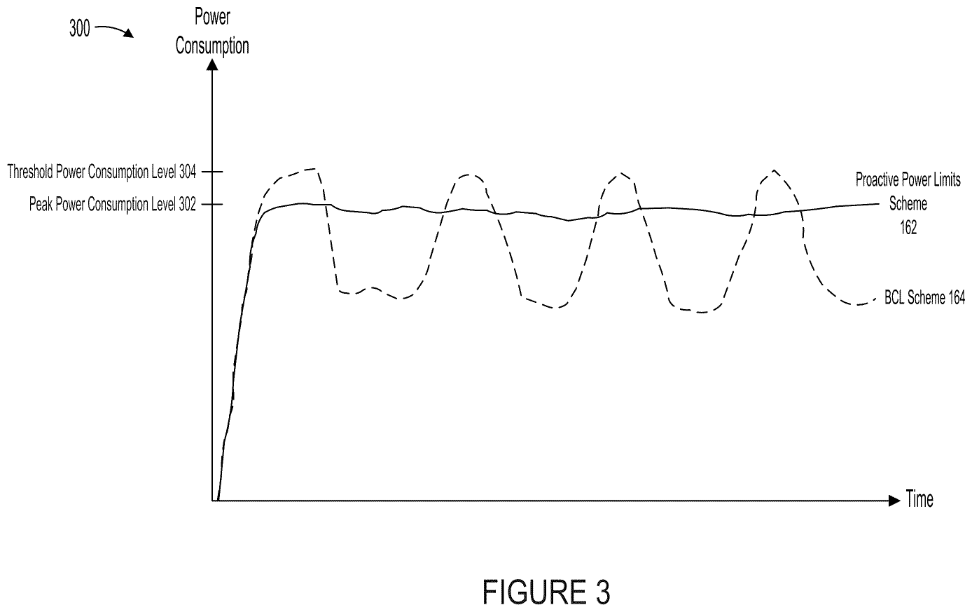

The SoC 102 may further include, or may execute, a proactive power manager 160. In some aspects, the proactive power manager 160 may operate in accordance with a proactive power limits scheme 162 that may be associated with the silicon anode battery 122. Further, in some implementations, the proactive power manager 160 may also operate in accordance with a battery current limiting (BCL) scheme 164. In some implementations, the proactive power limits scheme 162 may correspond to a “conservative” scheme, and the BCL scheme 164 may correspond to an “aggressive” scheme. As referred to herein, a “proactive power limits scheme” (such as the proactive power limits scheme 162) may refer to a scheme for managing power consumption that is associated with a peak power consumption level that is less than a threshold power consumption level associated with a BCL scheme, such as the BCL scheme 164. Some examples that may be associated with the proactive power limits scheme 162 and the BCL scheme 164 are described further with reference to FIGS. 2 and 3.

FIG. 2 depicts some examples that may be associated with the silicon anode battery 122 and that support silicon anode battery based power management. In the example of FIG. 2, the silicon anode battery 122 may be associated with a rated capacity 202, which may correspond to or may be referred to as a theorical capacity of the silicon anode battery 122. The rated capacity 202 may include a normal operating capacity 204 and an additional capacity 206 that is distinct from the normal operating capacity 204. To illustrate, in some examples, the normal operating capacity 204 may correspond to a range of one hundred percent charged to x percent charged, and the additional capacity 206 may correspond to a range of zero percent charged to x percent charged, where 0<x<100. The silicon anode battery 122 may be associated with a threshold charge level 210. In some examples, the threshold charge level 210 may correspond to, or may be based on, a boundary between the normal operating capacity 204 and the additional capacity 206 (e.g., where the threshold charge level 210 corresponds to x percent charged).

In some implementations, characteristics of the silicon anode battery 122 may change as charge is depleted from the silicon anode battery 122 (e.g., during operation of the device 100 of FIG. 1). To illustrate, as the silicon anode battery 122 is discharged, internal impedance of the of the silicon anode battery 122 may increase, which may reduce performance of one or more of silicon anode battery 122 or a device that operates using the silicon anode battery 122, such as the device 100. As a result, some conventional systems may operate a silicon anode battery only within the normal operating capacity 204 and may initiate or require recharging outside the normal operating capacity 204. In such systems, the additional capacity 206 may be unused.

To further illustrate, the normal operating capacity 204 may be associated with a first voltage and a first impedance of the silicon anode battery 122, and the additional capacity 206 may be associated with a second voltage and a second impedance of the silicon anode battery 122. The first voltage may be greater than the second voltage, and the first impedance may be less than the second impedance.

In some aspects of the disclosure, the proactive power manager 160 may perform one or more operations to enhance performance associated with the silicon anode battery 122. For example, in some implementations, the proactive power manager 160 may use the proactive power limits scheme 162 to enable use of the additional capacity 206 (e.g., to “unlock” the additional capacity 206). To further illustrate, in some examples, the proactive power manager 160 may operate based on the BCL scheme 164 while the charge of the silicon anode battery 122 is within the normal operating capacity 204 and may initiate operation based on the proactive power limits scheme 162 in accordance with detecting that the charge of the silicon anode battery 122 is within the additional capacity 206.

Although the example of FIG. 2 may illustrate one threshold charge level 210, it should be appreciated that multiple threshold charge levels 210 may be used. To illustrate, in some implementations, aging of the silicon anode battery 122 may change one or more of a capacity of the silicon anode battery 122 (e.g., by decreasing the capacity to be less than the rated capacity 202 of the silicon anode battery 122) or an internal impedance of the silicon anode battery 122 (e.g., by increasing the internal impedance of the silicon anode battery 122). In some such examples, the proactive power manager 160 may adjust the threshold charge level 210 in accordance with an age of the silicon anode battery 122.

FIG. 3 depicts a graph 300 illustrating some examples that support silicon anode battery based power management. In the example of FIG. 3, the abscissa of the graph 300 may correspond to time, and the ordinate of the graph 300 may correspond to power consumption of a device, such as the device 100, one or more other devices described herein, or a combination hereof.

In some conventional systems, a device may operate based on the BCL scheme 164, which may involve allowing power consumption to reach a threshold power consumption level 304 and then performing power consumption throttling to reduce power consumption below the threshold power consumption level 304. By allowing power consumption to reach the threshold power consumption level 304, poor performance may result (e.g., a battery “brownout”). To reduce or avoid such conditions, some conventional systems to avoid using the additional capacity 206 (e.g., to reduce or avoid battery brownouts).

In some aspects of the disclosure, the proactive power manager 160 may reduce power consumption associated with the device 100 to maintain the power consumption below a peak power consumption level 302 that is less than the threshold power consumption level 304. In some aspects, by maintaining the power consumption below the peak power consumption level 302, the proactive power manager 160 may enable use of the additional capacity 206 of the silicon anode battery 122 while reducing or avoiding battery brownouts.

Operation of a device based on the proactive power limits scheme 162 may improve one or more performance characteristics of the device as compared to the BCL scheme 164. For example, power consumption of the device based on the proactive power limits scheme 162 may be associated with a first variance (or standard deviation), and the power consumption of the device based on the BCL scheme 164 may be associated with a second variance greater than the first variance (or a second standard deviation greater than the first standard deviation). In such examples, the power consumption of the device may be associated with the first variance during operation of the device based on the peak power consumption level 302, and the power consumption of the device may be associated with the second variance during operation of the device based on power consumption throttling upon reaching the threshold power consumption level 304.

Although some examples herein may describe the proactive power limits scheme 162 separately from the BCL scheme 164, other examples may use both the proactive power limits scheme 162 separately from the BCL scheme 164. For example, in some implementations, the proactive power manager 160 may use the proactive power limits scheme 162 as a primary (or “preferred”) scheme and may use the BCL scheme 164 as a secondary (or “fallback”) scheme. To further illustrate, in some cases, the proactive power manager 160 may detect one or more conditions associated with exceeding the peak power consumption level 302. As an illustrative example, some devices may include a backup power source, such as a backup battery or a capacitive power bank, in which case a battery brownout of a primary battery may be acceptable. In some such examples, after detecting the one or more conditions associated with exceeding the peak power consumption level 302, the proactive power manager 160 may perform power consumption throttling in accordance with the BCL scheme 164.

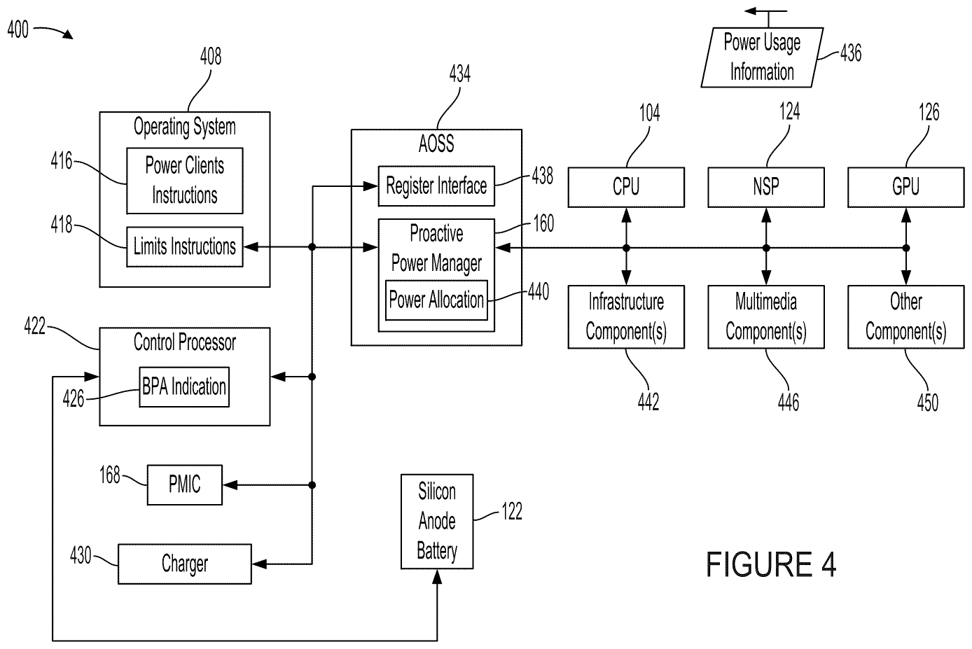

FIG. 4 depicts an example of a device 400 that supports silicon anode battery based power management. In some examples, the device 400 may be included in the device 100 of FIG. 1 or may include one or more components described with reference to FIG. 1. For example, the device 400 may include one or more of the CPU 104, the NSP 124, the GPU 126, the silicon anode battery 122, the PMIC 168, or one or more other components.

In the example of FIG. 4, the device 400 may include, or may execute, an operating system 408. The operating system 408 may be executed by one or more processors described herein, such as one or more processors of the SoC 102 of FIG. 1. In some examples, the operating system 408 may include power clients instructions 416 and limits instructions 418. The device 400 may further include a control processor 422, a charger, and an always-on subsystem (AOSS) 434.

In some implementations, the AOSS 434 may include, or may execute, the proactive power manager 160. For example, the AOSS 434 may include one or more processors and a memory coupled to the one or more processors. The memory may store instructions executable by the one or more processors to initiate, perform, or control one or more operations described with reference to the proactive power manager 160. Alternatively, or in addition, the memory may be external to the AOSS 434. For example, the AOSS 434 may be coupled to the memory 106 of FIG. 1.

The AOSS 434 may be coupled to the control processor 422, to the PMIC 168, and to the charger 430 via one or more buses. Further, one or more of the AOSS 434, the control processor 422, the PMIC 168, or the charger 430 may communicate with the operating system 408 (or with one or more processors that execute the operating system 408), such as via the one or more buses. In some examples, the AOSS 434 may include a register interface 438 that is configured to communicate with (e.g., interface with) one or more of the operating system 408, the control processor 422, the PMIC 168, or the charger 430. In some examples, the register interface 438 may include a memory-mapped input/output (MMIO) interface.

The device 400 may further include one or more infrastructure components 442, one or more multimedia components 446, and one or more other components 450. The one or more other components 450 may include, for example, one or more components of FIG. 1, such as one or more of the microphone array 130, the display 114, the I/O hub 116, the WAN adaptor 152, the LAN adaptor 153, the PAN adaptor 154, the memory 106, the audio circuitry 156, the speaker 120, or one or more other components. In some examples, the AOSS 434 may be coupled to the CPU 104, the NSP 124, the GPU 126, the one or more infrastructure components 442, the one or more multimedia components 446, and the one or more other components 450 via one or more buses.

During operation, the device 400 may operate based at least in part on the proactive power limits scheme 162 (e.g., using one or more operations performed by the proactive power manager 160). Operation based on the proactive power limits scheme 162 may enable the device 400 to operate within the additional capacity 206 of the silicon anode battery 122 while reducing or avoiding battery brownouts.

To illustrate, in some examples, the AOSS 434 may receive power usage information 436 associated with the device 400. The power usage information 436 may indicate, for one or more components of the device 400, an amount of power used (or estimated to be used) by the component. In some examples, the power usage information 436 may be received from the one or more components, such as from one or more of the CPU 104, the NSP 124, the GPU 126, the one or more infrastructure components 442, the one or more multimedia components 446, or the one or more other components 450. In some other examples, the power usage information 436 may be received from one or more other components, such as from the PMIC 168.

The device 400 may also receive, or may determine, a battery power availability (BPA) indication 426 associated with the silicon anode battery 122. The BPA indication 426 may indicate an amount of remaining charge of the silicon anode battery 122, such as one or more of a percentage charged metric, a remaining operating time metric, or a voltage level of the silicon anode battery 122. Alternatively, or in addition, the BPA indication 426 may indicate one or more other metrics. For example, in some implementations, the BPA indication 426 may indicate an internal impedance associated with the silicon anode battery 122, which may be indicative of (or correlated with) the amount of remaining charge of the silicon anode battery 122 (e.g., where internal impedance decreases with increased charge).

In some examples, the control processor 422 may receive the BPA indication 426 from the silicon anode battery 122 or may determine the BPA indication 426 based on information received from the silicon anode battery 122. In some examples, the control processor 422 may provide the BPA indication 426 to the AOSS 434 (e.g., via the register interface 438).

The AOSS 434 may determine, or may adjust, a power allocation 440 associated with the device 400 based on the power usage information 436 and the BPA indication 426. In some examples, the proactive power manager 160 may adjust the power allocation 440 to enable the operation of the device 400 based on the peak power consumption level 302 of FIG. 2. In some examples, adjusting the power allocation 440 may include, for example, reducing operation of one or more components of the device 400 such that power consumption of the device 400 stays at or below the peak power consumption level 302 (e.g., instead of letting the power consumption rise to the threshold power consumption level 304).

To further illustrate, in some examples, the proactive power manager 160 may perform a comparison of the BPA indication 426 to a threshold, such as the threshold charge level 210 of FIG. 2. In some examples, the proactive power manager 160 may include a comparator circuit that is configured to perform the comparison and to output a signal having a value indicating a result of the comparison. The proactive power manager 160 may determine, based on the comparison, whether the BPA indication 426 satisfies the threshold charge level 210. For example, if the BPA indication 426 indicates a voltage level of the silicon anode battery 122 is less than the threshold charge level 210, then the proactive power manager 160 may determine that the BPA indication 426 fails to satisfy the threshold charge level 210. In some other examples, the proactive power manager 160 may determine that the BPA indication 426 satisfies the threshold charge level 210, such as if the BPA indication 426 indicates a voltage level of the silicon anode battery 122 is greater than (or greater than or equal to) the threshold charge level 210.

Based on the BPA indication 426 failing to satisfy the threshold charge level 210, the proactive power manager 160 may adjust operation of the device 400 from the BCL scheme 164 to operation of the device 400 based on the proactive power limits scheme 162. In such examples, adjusting the power allocation 440 may include adjusting operation of the device 400 from the BCL scheme 164 to operation of the device 400 based on the proactive power limits scheme 162.

Alternatively, or in addition, the proactive power manager 160 may adjust the power allocation 440 based on whether the BPA indication 426 is within the normal operating capacity of the silicon anode battery 122 or is within the additional capacity of the silicon anode battery 122. In some examples, adjusting the power allocation 440 may include adjusting operation of the device 400 from the BCL scheme 164 to operation of the device 400 based on the BPA indication 426 being within the additional capacity of the silicon anode battery 122. In some other examples, the adjusting the power allocation 440 may include adjusting (or maintaining) operation of the device 400 based on the BCL scheme 164 in accordance with the BPA indication 426 being within the normal operating capacity of the silicon anode battery 122.

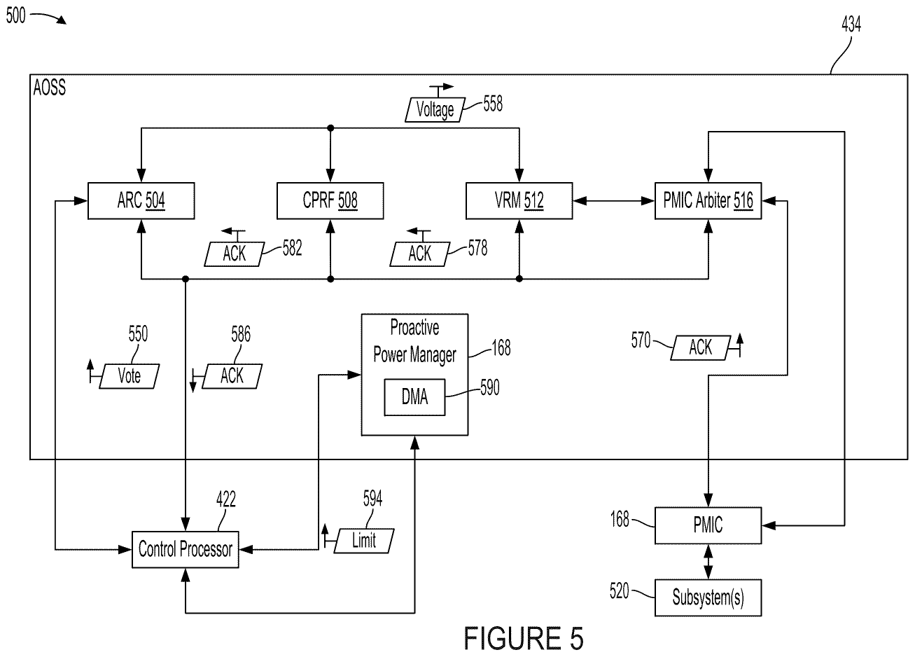

FIG. 5 depicts an example of a device 500 that supports silicon anode battery based power management. In some examples, the device 500 may be included in the device 100 of FIG. 1, may be included in the device 400 of FIG. 4, or may include one or more components described with reference to FIGS. 1 and 4. For example, the device 500 may include one or more of the AOSS 434, the control processor 422, or the PMIC 168.

The AOSS 434 may be coupled to the control processor 422 and to the PMIC 168. The PMIC 168 may be coupled to one or more subsystems 520. In some examples, the one or more subsystems 520 may include one or more components described with reference to FIGS. 1 and 4, such as one or more of the CPU 104, the NSP 124, the GPU 126, the one or more infrastructure components 442, the one or more multimedia components 446, or the one or more other components 450.

The AOSS 434 may include an application resource controller (ARC) 504, a clock and power resource framework (CPRF) 508, a voltage regulation module (VRM) 512, and a PMIC arbiter 516. The ARC 504, the CPRF 508, the VRM 512, and the PMIC arbiter 516 may be coupled to one another, and to the control processor 422, via one or more buses. The PMIC arbiter 516 may also be coupled to the PMIC 168. The AOSS 434 may further include the proactive power manager 160. The proactive power manager 160 may be coupled to the control processor 422.

During operation, the device 500 may perform one or more power management operations. In some examples, the one or more power management operations may enable a power consumption of the one or more subsystems 520 to remain less than the peak power consumption level 302.

To illustrate, in some examples, the control processor 422 may provide a vote 550 to the ARC 504. In some examples, the vote 550 may indicate an amount of power consumption of one or more components of the device 500, such as the one or more subsystems 520. The vote 550 may also include, or may be referred to as, an aggregated vote. The ARC 504 may send the vote 550 to the CPRF 508.

The CPRF 508 may determine a voltage 558 based on the vote 550. In some implementations, the CPRF 508 may store a lookup table indicating a mapping of votes to voltages, and the CPRF 508 may select the voltage 558 from among the voltages indicated by the lookup table based on the voltage 558. The voltage 558 may correspond to an operating voltage to be implemented at one or more components (such as the one or more subsystems 520), where the operating voltage is selected based on the vote 550. To illustrate, as the amount of power consumption indicated by the voltage 558 increases (or decreases), the voltage 558 may increase (or decrease).

The CPRF 508 may provide an indication of the voltage 558 to the VRM 512, and the VRM 512 may provide an indication of the voltage 558 to the PMIC 168 (e.g., via the PMIC arbiter 516). The PMIC 168 may provide an acknowledgement (ACK) 570 of the voltage 558 to the VRM 512 (e.g., via the PMIC arbiter 516). Based on the ACK 570, the VRM 512 may provide an ACK 578 to the CPRF 508. Based on the ACK 578, the CPRF 508 may provide an ACK 582 to the ARC 504. Based on the ACK 582, the ARC 504 may provide an ACK 586 to the control processor 422.

Based on the ACK 586, the device 500 may perform a direct memory access (DMA) operation 590. Performing the DMA operation 590 may include receiving, by the proactive power manager 160, an indication of a limit 594 from the control processor 422. The limit may be associated with the proactive power limits scheme 162 and with the peak power consumption level 302. In some examples, adjusting an operating voltage of the one or more subsystems 520 based on the limit 594 may enable the power consumption associated with the vote 550. The power consumption may be less than the peak power consumption level 302 of FIG. 3. Accordingly, by providing the vote 550 to the AOSS 434, the control processor 422 may provide the indication of the limit 594 to the proactive power manager 160, limiting power consumption of the one or more subsystems based on the peak power consumption level 302.

To further illustrate, Table 1 indicates examples of power management that may be applied via the limit 594. In the example of Table 1, values of the limit 594 (indicated in the left column of Table 1) may be used to enable power management operations (indicated in the middle column of Table 1) for particular durations (indicated in the right column of Table 1). In some implementations, the examples of Table 1 may correspond to, or may be specified by, the proactive power limits scheme 162.

TABLE 1

| Example | | | |
|---|---|---|---|
| Value of | Example Power Management | Example | |
| Limit 594 | Operation | Duration | |
| 1 | Sustained system power limit | 100 | seconds |
| | managing thermal and user | | |
| | preference (e.g., acoustics) | | |
| 2 | Sustained system power limit | 100 | seconds |
| | managing battery and power | | |
| | adapter limit | | |
| 3 | Short term burst battery power | 3 | seconds |
| | limit | | |
| 4 | Electrical limit of battery and/or | 10 | milliseconds |
| | adapter over short duration | | |
| 5 | Sustained SoC power limit | 100 | seconds |
| | managing power balancing across | | |
| | system components | | |
| 6 | Burst SoC power limit managing | 10 | seconds |
| | thermal solution capability (e.g., | | |
| | heat pipe dry out) | | |
| 7 | Short-term SoC power limit | 10 | milliseconds |
| | managing peak battery discharge | | |
| | rates | | |
| 8 | Very short-term SoC power limit | 10 | microseconds |

for managing electrical limits

In the example of Table 1, different values of the limit 594 may be used to limit overall system power consumption (e.g., via any of the values 1, 2, 3, and 4). Alternatively, or in addition, different values of the limit 594 may be used to limit power consumption of the SoC 102 (e.g., via any of the values 5, 6, 7, and 8). In some examples, the proactive power manager 160 may include one or more processors and a memory coupled to the one or more processors. The memory may store a lookup table (or other data) indicating the information of Table 1. The one or more processors may access the lookup table to manage power consumption in accordance with the proactive power limits scheme 162.

To further illustrate, in some implementations, adjusting the power allocation 440 may include adjusting operation of one or more components from parameters of one row of Table 1 to parameters of another row of Table 1. In another example, adjusting the power allocation 440 may include adjusting operation of one or more components from a “default” mode to a “temporary” mode corresponding to a row of Table 1. Other examples are also within the scope of the disclosure.

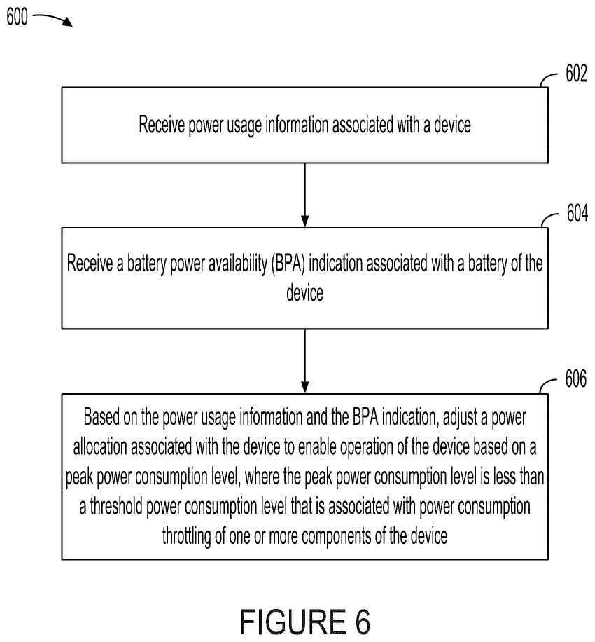

FIG. 6 is a flow chart illustrating an example of a method 600 of operation of a device that supports silicon anode battery based power management. In some examples, the device may correspond to one or more of the devices described herein, such as one or more of the device 100, the device 400, or the device 500, as illustrative examples. In some examples, the method 600 may be performed by the proactive power manager 160.

The method 600 includes receiving power usage information associated with the device, at 602. For example, the proactive power manager 160 may receive the power usage information 436 from one or more components of the device, such as one or more of the CPU 104, the NSP 124, the GPU 126, the one or more infrastructure components 442, the one or more multimedia components 446, or the one or more other components 450.

The method 600 further includes receiving a battery power availability (BPA) indication associated with a battery of the device, at 604. For example, the proactive power manager 160 may receive the BPA indication 426 (e.g., from the control processor 422 or from the silicon anode battery 122).

The method 600 further includes, based on the power usage information and the BPA indication, adjusting a power allocation associated with the device to enable operation of the device based on a peak power consumption level, at 606. The peak power consumption level is less than a threshold power consumption level that is associated with power consumption throttling of one or more components of the device. For example, the proactive power manager 160 may adjust the power allocation 440 to enable operation of the device based on the peak power consumption level 302. The peak power consumption level 302 may be less than the threshold power consumption level 304.

In some aspects, a processing system may include one or more memories and one or more processors coupled to the one or more memories. In some examples, the one or more processors may include one or more of the AOSS 434, the control processor 422, or one or more other processors. The one or more memories may include, for example, the memory 106. The processing system may be configured to perform one or more operations described herein, such as one or more operations of the method 600 of FIG. 6.

Alternatively, or in addition, a non-transitory computer-readable medium may store instructions executable by one or more processors to initiate, perform, or control one or more operations described herein. The one or more operations may include, for example, one or more operations of the method 600 of FIG. 6. In some examples, the one or more processors may include one or more of the AOSS 434, the control processor 422, or one or more other processors. The one or more memories may include the memory 106, and the instructions may include any of the instructions 108, the power clients instructions 416, the limits instructions 418, or other instructions.

Although certain examples may be described with reference to a silicon anode battery for illustration, other examples are also within the scope of the disclosure. To illustrate, one or more features described herein (such as the proactive power limits scheme 162) may be used in connection with other types of battery technologies, such as other types of rechargeable batteries (e.g., other types of rechargeable lithium ion batteries). In some examples, one or more features described with reference to the silicon anode battery 122 may be used in connection with one or more of a graphite anode battery, a lithium anode battery, a lithium-sulfur anode battery, a silicon-graphene composite anode battery, or another type of battery, as illustrative examples.

One or more features described herein may improve operation of a device that uses battery power. To illustrate, some technologies may avoid use of silicon anode batteries due to the relatively high resistances of silicon anode batteries at low charge levels, which may reduce ability of the devices to draw current. As a result, such devices may use some other types of batteries (such as graphite-based batteries) in order to avoid the higher resistances associated with silicon anode batteries. In some aspects, the proactive power manager 160 may use the proactive power limits scheme 162 to selectively reduce current drawn from the silicon anode battery 122 when the silicon anode battery 122 is associated with a low charge level (e.g., where a charge level of the silicon anode battery 122 fails to satisfy the threshold charge level 210). As a result, the proactive power limits scheme 162 may enable use of silicon anode batteries in a variety of devices, which may enable benefits including, for example, faster charging and discharging, higher energy density, reduced equivalent series resistance (ESR), and “untapped” extra battery capacity at low charge levels as compared to other types of batteries, such as some graphite-based batteries.

In a first aspect, an apparatus for power management of a device includes a processing system including one or more processors and one or more memories coupled to the one or more processors. The processing system is configured to receive power usage information associated with the device and to receive a battery power availability (BPA) indication associated with a battery of the device. The processing system is further configured to adjust, based on the power usage information and the BPA indication, a power allocation associated with the device to enable operation of the device based on a peak power consumption level. The peak power consumption level is less than a threshold power consumption level that is associated with power consumption throttling of one or more components of the device.

In a second aspect, in combination with the first aspect, the peak power consumption level is associated with a proactive power limits scheme associated with the battery, and the threshold power consumption level is associated with a battery current limiting (BCL) scheme.

In a third aspect, in combination with one or more of the first aspect or the second aspect, the processing system is further configured to detect one or more conditions associated with exceeding the peak power consumption level and to perform the power consumption throttling of the one or more components in accordance with the BCL scheme.

In a fourth aspect, in combination with one or more of the first aspect through the third aspect, the processing system is further configured to perform a comparison of the BPA indication to a threshold charge level, to determine, based on the comparison, whether the BPA indication fails to satisfy the threshold charge level, and based on the BPA indication failing to satisfy the threshold charge level, to adjust from operation of the device based on the BCL scheme to operation of the device based on the proactive power limits scheme.

In a fifth aspect, in combination with one or more of the first aspect through the fourth aspect, the processing system is further configured to determine whether the BPA indication is within a normal operating capacity of the battery or an additional capacity of the battery that is distinct from the normal operating capacity, and the power allocation is adjusted further based on the BPA indication being within the additional capacity of the battery.

In a sixth aspect, in combination with one or more of the first aspect through the fifth aspect, power consumption of the device is associated with a first variance during operation of the device based on the peak power consumption level, and the power consumption of the device is associated with a second variance during operation of the device based on the power consumption throttling, the first variance less than the second variance.

In a seventh aspect, in combination with one or more of the first aspect through the sixth aspect, to adjust the power allocation, the processing system is further configured to receive, at an always-on subsystem (AOSS), a vote from a control processor, to generate, based on the vote, an indication of a voltage, and to provide the indication of the voltage to a power management integrated circuit (PMIC).

In an eighth aspect, in combination with one or more of the first aspect through the seventh aspect, to adjust the power allocation, the processing system is further configured to receive an acknowledgement (ACK) from the PMIC based on the indication of the voltage and to perform, based on the ACK, a direct memory access (DMA) operation with the control processor to receive an indication of a limit associated with the peak power consumption level.

In a ninth aspect, a method of power management for a device includes receiving power usage information associated with the device and receiving a battery power availability (BPA) indication associated with a battery of the device. The method further includes, based on the power usage information and the BPA indication, adjusting a power allocation associated with the device to enable operation of the device based on a peak power consumption level. The peak power consumption level is less than a threshold power consumption level that is associated with power consumption throttling of one or more components of the device.

In a tenth aspect, in combination with the ninth aspect, the peak power consumption level is associated with a proactive power limits scheme associated with the battery, and the threshold power consumption level is associated with a battery current limiting (BCL) scheme.

In an eleventh aspect, in combination with one or more of the ninth aspect through the tenth aspect, the method further includes detecting one or more conditions associated with exceeding the peak power consumption level and performing the power consumption throttling of the one or more components in accordance with the BCL scheme.

In a twelfth aspect, in combination with one or more of the ninth aspect through the eleventh aspect, the method further includes performing a comparison of the BPA indication to a threshold charge level, determining, based on the comparison, whether the BPA indication fails to satisfy the threshold charge level, and based on the BPA indication failing to satisfy the threshold charge level, adjusting from operation of the device based on the BCL scheme to operation of the device based on the proactive power limits scheme.

In a thirteenth aspect, in combination with one or more of the ninth aspect through the twelfth aspect, the method further includes determining whether the BPA indication is within a normal operating capacity of the battery or an additional capacity of the battery that is distinct from the normal operating capacity, and the power allocation is adjusted further based on the BPA indication being within the additional capacity of the battery.

In a fourteenth aspect, in combination with one or more of the ninth aspect through the thirteenth aspect, power consumption of the device is associated with a first variance during operation of the device based on the peak power consumption level, and the power consumption of the device is associated with a second variance during operation of the device based on the power consumption throttling, the first variance less than the second variance.

In a fifteenth aspect, in combination with one or more of the ninth aspect through the fourteenth aspect, adjusting the power allocation includes receiving, at an always-on subsystem (AOSS), a vote from a control processor, generating, based on the vote, an indication of a voltage, and providing the indication of the voltage to a power management integrated circuit (PMIC).

In a sixteenth aspect, in combination with one or more of the ninth aspect through the fifteenth aspect, adjusting the power allocation further includes receiving an acknowledgement (ACK) from the PMIC based on the indication of the voltage and performing, based on the ACK, a direct memory access (DMA) operation with the control processor to receive an indication of a limit associated with the peak power consumption level.

In a seventeenth aspect, a non-transitory computer-readable medium stores instructions executable by one or more processors to initiate, perform, or control operations for power management of a device. The operations include receiving power usage information associated with the device and receiving a battery power availability (BPA) indication associated with a battery of the device. The operations further include, based on the power usage information and the BPA indication, adjusting a power allocation associated with the device to enable operation of the device based on a peak power consumption level. The peak power consumption level is less than a threshold power consumption level that is associated with power consumption throttling of one or more components of the device.

In an eighteenth aspect, in combination with the seventeenth aspect, the peak power consumption level is associated with a proactive power limits scheme associated with the battery, and the threshold power consumption level is associated with a battery current limiting (BCL) scheme.

In a nineteenth aspect, in combination with one or more of the seventeenth aspect through the eighteenth aspect, the operations further include detecting one or more conditions associated with exceeding the peak power consumption level and performing the power consumption throttling of the one or more components in accordance with the BCL scheme.

In a twentieth aspect, in combination with one or more of the seventeenth aspect through the nineteenth aspect, the operations further include performing a comparison of the BPA indication to a threshold charge level, determining, based on the comparison, whether the BPA indication fails to satisfy the threshold charge level, and adjusting, based on the BPA indication failing to satisfy the threshold charge level, from operation of the device based on the BCL scheme to operation of the device based on the proactive power limits scheme.

In the figures, a single block may be described as performing a function or functions. The function or functions performed by that block may be performed in a single component or across multiple components, and/or may be performed using hardware, software, or a combination of hardware and software. To illustrate, various illustrative components, blocks, modules, circuits, and operations may be described in terms of functionality. Whether such functionality is implemented as hardware or software may depend upon the particular application and the overall system design. Skilled artisans may implement the described functionality in varying ways for each particular application, but such implementation decisions should not be interpreted as causing a departure from the scope of the disclosure. Also, the example devices may include components other than those shown, including well-known components such as a processor, memory, and the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (such as application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc, where disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 5, 5, or 50 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus for power management of a device, the apparatus comprising:
a processing system including one or more processors and one or more memories coupled to the one or more processors, the processing system configured to:
receive power usage information associated with the device;
receive a battery power availability (BPA) indication associated with a battery of the device; and
based on the power usage information and the BPA indication, adjust a power allocation associated with the device to enable operation of the device based on a peak power consumption level, wherein the peak power consumption level is less than a threshold power consumption level that is associated with power consumption throttling of one or more components of the device.

2. The apparatus of claim 1, wherein the peak power consumption level is associated with a proactive power limits scheme associated with the battery, and wherein the threshold power consumption level is associated with a battery current limiting (BCL) scheme.

3. The apparatus of claim 2, wherein the processing system is further configured to:
detect one or more conditions associated with exceeding the peak power consumption level; and
perform the power consumption throttling of the one or more components in accordance with the BCL scheme.

4. The apparatus of claim 2, wherein the processing system is further configured to:
perform a comparison of the BPA indication to a threshold charge level;
based on the comparison, determine whether the BPA indication fails to satisfy the threshold charge level; and
based on the BPA indication failing to satisfy the threshold charge level, adjust from operation of the device based on the BCL scheme to operation of the device based on the proactive power limits scheme.

5. The apparatus of claim 1, wherein the processing system is further configured to determine whether the BPA indication is within a normal operating capacity of the battery or an additional capacity of the battery that is distinct from the normal operating capacity, and wherein the power allocation is adjusted further based on the BPA indication being within the additional capacity of the battery.

6. The apparatus of claim 1, wherein power consumption of the device is associated with a first variance during operation of the device based on the peak power consumption level, and wherein the power consumption of the device is associated with a second variance during operation of the device based on the power consumption throttling, the first variance less than the second variance.

7. The apparatus of claim 1, wherein, to adjust the power allocation, the processing system is further configured to:
receive, at an always-on subsystem (AOSS), a vote from a control processor;
generate, based on the vote, an indication of a voltage; and
provide the indication of the voltage to a power management integrated circuit (PMIC).

8. The apparatus of claim 7, wherein, to adjust the power allocation, the processing system is further configured to:
receive an acknowledgement (ACK) from the PMIC based on the indication of the voltage; and
based on the ACK, perform a direct memory access (DMA) operation with the control processor to receive an indication of a limit associated with the peak power consumption level.

9. A method of power management for a device, the method comprising:
receiving power usage information associated with the device;
receiving a battery power availability (BPA) indication associated with a battery of the device; and
based on the power usage information and the BPA indication, adjusting a power allocation associated with the device to enable operation of the device based on a peak power consumption level, wherein the peak power consumption level is less than a threshold power consumption level that is associated with power consumption throttling of one or more components of the device.

10. The method of claim 9, wherein the peak power consumption level is associated with a proactive power limits scheme associated with the battery, and wherein the threshold power consumption level is associated with a battery current limiting (BCL) scheme.

11. The method of claim 10, further comprising:
detecting one or more conditions associated with exceeding the peak power consumption level; and
performing the power consumption throttling of the one or more components in accordance with the BCL scheme.

12. The method of claim 10, further comprising:
performing a comparison of the BPA indication to a threshold charge level;
based on the comparison, determining whether the BPA indication fails to satisfy the threshold charge level; and
based on the BPA indication failing to satisfy the threshold charge level, adjusting from operation of the device based on the BCL scheme to operation of the device based on the proactive power limits scheme.

13. The method of claim 9, further comprising determining whether the BPA indication is within a normal operating capacity of the battery or an additional capacity of the battery that is distinct from the normal operating capacity, wherein the power allocation is adjusted further based on the BPA indication being within the additional capacity of the battery.

14. The method of claim 9, wherein power consumption of the device is associated with a first variance during operation of the device based on the peak power consumption level, and wherein the power consumption of the device is associated with a second variance during operation of the device based on the power consumption throttling, the first variance less than the second variance.

15. The method of claim 9, wherein adjusting the power allocation includes:
receiving, at an always-on subsystem (AOSS), a vote from a control processor;
generating, based on the vote, an indication of a voltage; and
providing the indication of the voltage to a power management integrated circuit (PMIC).

16. The method of claim 15, wherein adjusting the power allocation further includes:
receiving an acknowledgement (ACK) from the PMIC based on the indication of the voltage; and
based on the ACK, performing a direct memory access (DMA) operation with the control processor to receive an indication of a limit associated with the peak power consumption level.

17. A non-transitory computer-readable medium storing instructions executable by one or more processors to initiate, perform, or control operations for power management of a device, the operations comprising:
receiving power usage information associated with the device;
receiving a battery power availability (BPA) indication associated with a battery of the device; and
based on the power usage information and the BPA indication, adjusting a power allocation associated with the device to enable operation of the device based on a peak power consumption level, wherein the peak power consumption level is less than a threshold power consumption level that is associated with power consumption throttling of one or more components of the device.

18. The non-transitory computer-readable medium of claim 17, wherein the peak power consumption level is associated with a proactive power limits scheme associated with the battery, and wherein the threshold power consumption level is associated with a battery current limiting (BCL) scheme.

19. The non-transitory computer-readable medium of claim 18, wherein the operations further comprise:
detecting one or more conditions associated with exceeding the peak power consumption level; and
performing the power consumption throttling of the one or more components in accordance with the BCL scheme.

20. The non-transitory computer-readable medium of claim 18, wherein the operations further comprise:
performing a comparison of the BPA indication to a threshold charge level;
based on the comparison, determining whether the BPA indication fails to satisfy the threshold charge level; and
based on the BPA indication failing to satisfy the threshold charge level, adjusting from operation of the device based on the BCL scheme to operation of the device based on the proactive power limits scheme.
